(19) United States
(12) Patent Application Publication
(10) Pub. No.: US 2002/0169808 A1
(43) Pub. Date: Nov. 14, 2002

(54) System and method for reordering data

(76) Inventor: Eric C. Fromm, Eau Claire, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/017,972

(22) Filed: Dec. 12, 2001

Related U.S. Application Data
(60) Provisional application No. 60/255,047, filed on Dec. 12, 2000.

(51) Int. Cl. G06F 7/00

(52) U.S. Cl. 708/204; 708/209

(57) ABSTRACT

Apparatus and methods for reordering bits in a data element according to a desired pattern. The desired pattern is used to generate a sequence of masks. Masking operators apply the masks in masking operations to reorder the bits in the data element.

### FIELD OF THE INVENTION

The present invention relates to apparatus and methods useful for reordering bits in a data element according to a desired pattern. More specifically, the present invention utilizes a centrifuge operation to accomplish such reorderings.

### BACKGROUND OF THE INVENTION

In the computing industry, there is occasionally a need to reorder some or all of the bits in one or more data elements according to a desired reordering pattern. A data element is commonly referred to as a word. A data element or word can comprise any number of bits, but usually the number of bits is a power of two. In computing applications a data element may represent information such as a pixel in a graphical image, a character in a text application, or even a computer instruction.

One approach to reordering the bits in a data element is to write a computer program (that is, a software approach) that takes as input the data element or elements to be reordered and a reordering pattern and outputs a data element or elements having the bits reordered according to the reordering pattern. However, a software approach would be inefficient or slow, especially for an application calling for reordering large numbers of data elements.

Another approach to reordering the bits in one or more data elements would be to implement what will be referred to as a brute hardware approach. This hardware approach would require approximately n² multiplexors to reorder n bits in a data element. Such an approach would be fast, but would be difficult to implement due to the complexity and size of the circuitry needed.

Accordingly, there is still a need in the industry for apparatus and methods for reordering the bits in a data element according to a desired reorder pattern.

### SUMMARY OF THE INVENTION

The present invention addresses one or more of the problems identified above by providing apparatus and methods for reordering the bits in a data element according to a desired reorder pattern. In one aspect, the present invention, provides methods that use one or more centrifuge operations to reorder the bits in a data element. The centrifuge operations use masks that are derived from the desired reorder pattern. In one embodiment of the present invention, n bits in a data element are reordered using log(n) masking operations.

In a second aspect, the present invention is a device adapted to reorder bits in a data element in accordance with a desired reorder pattern. Devices according to the present invention comprise a sequence of masks derived from the desired reorder pattern and one or more centrifuge operators adapted to utilize the sequence of masks to perform centrifuging operations. To reorder n bits in a data element, the actual number of masking operators used according to the present invention may vary. For example, in one embodiment, the present invention provides for a data element to make log(n) passes through a single centrifuge element. The centrifuge uses a sequence of different masks to accomplish the reordering. In another embodiment, the present invention provides for a data element to pass through log(n) different centrifuge stages, where each of the centrifuge stages applies a single mask that may be different from any of the masks applied by the other centrifuge stages.

### DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

FIG. 1 illustrates a reordering of an 8-bit data element.

FIG. 2 illustrates a centrifuge operation on an 8-bit data element.

FIG. 3 illustrates an example of mask creation according to an embodiment of the present invention.

FIG. 4 illustrates an example of a reordering according to an embodiment of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconciliable inconsistencies, the usage in this document controls.

Some portions of the following detailed description are presented in terms of algorithms and symbolic representations of operations on data bits within a computer memory. These algorithmic descriptions and representations are the ways used by those skilled in the data processing arts to most effectively convey the substance of their work to others skilled in the art. An algorithm includes a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

The present invention provides apparatus and methods for reordering bits in data elements in accordance with a desired reordering pattern. By data element it is meant any sequence of bits regardless of what kind of data they may represent. For example, data elements could represent pixels in a graphical image, text characters, or even computer instructions. By desired ordering pattern it is meant that each bit in the data element to be reordered has a desired or known destination position in the resulting or output data element. Each bit in the destination should have a unique destination position. That is, no two bits in the data element to be reordered are mapped into the same destination position. This destination position in the resulting data element will be referred to as the destination tag. For purposes of the present specification, n will refer to the number of bits in each data element that need to be reordered. Each destination tag can be expressed in binary notation using log(n) bits. Unless stated otherwise all logarithms in the present specification will refer to base 2 logarithms.

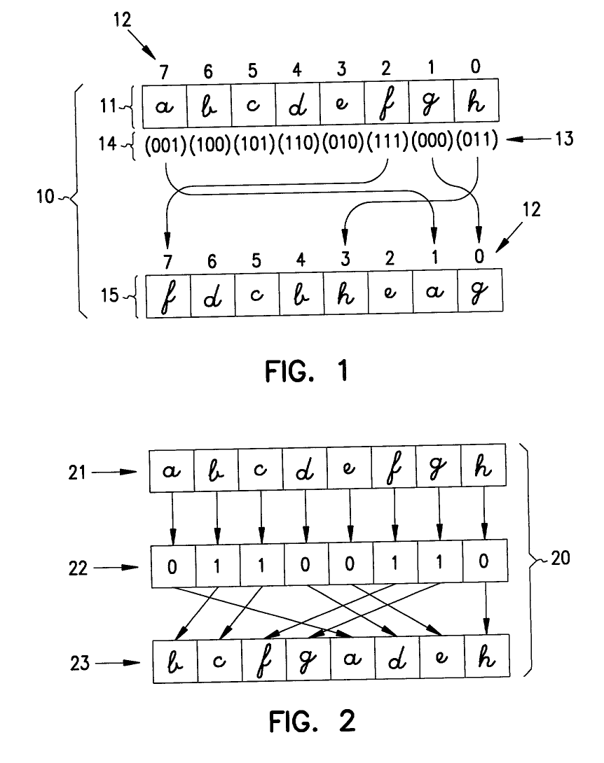

FIG. 1 illustrates a reordering 10 of an 8-bit data element 11 to form a reordered data element 15. The data element 11 and reordered data element 15 have position numbers 12 describing the position of each bit in each data element. These position numbers can be expressed in binary format using log(n) bits for each position. For example, in the reordering 10 of an 8-bit data element 11 each bit position has a unique 3-bit binary number that identifies that position. Thus, in any reordering of an n-bit data element, each bit in the data element will have a log(n)-bit destination bit position. This destination bit position is referred to as the destination tag 13 and represents the position in the output data element into which the bit is to be moved. In FIG. 1 for example, the bit h in bit position 0 of data element 11 has a destination tag of 011 indicating that bit h is to be moved to position 011 (or 3) according to reordering 10. Similarly, bit g is to be moved to position 000, bit f is to be moved to position 111, and bit a is to be moved to position 001. The collection of destination tags is referred to as a destination descriptor 14. By describing where each bit in a reordering pattern is to be moved, a destination descriptor defines the reordering.

In accordance with the present invention, the destination tags are used to create masks to be used in centrifuge operations. Generally, a centrifuge operation uses the bit pattern in a mask to shift bits in a data element either to the right or to the left depending on whether the corresponding bit in the mask is a 0 or a 1. FIG. 2 illustrates an example of a masking operation 20. In FIG. 2, the bits in data element 21 (represented by letters a through h) are shifted according to mask 22, resulting in output data element 23. In masking operation 20, a 1 bit in the mask 22 results in the corresponding bit being shifted to the left and a 0 bit results in the corresponding bit being shifted to the right.

Centrifuge operations and masks used in centrifuge operations are described in U.S. Pat. No. 5,696,922; U.S. Pat. No. 5,900,023; and U.S. Pat. No. 6,119,198, which descriptions are incorporated herein by reference.

In one embodiment, masks for use in a centrifuge operation are produced in accordance with the present invention in the following manner. The first mask is created by taking the most significant (leftmost) bit from each destination tag in a destination descriptor and placing it in the corresponding bit position in the first mask. That is, the most significant bit in the destination tag corresponding to bit 7 becomes the bit in position 7 of the first mask, the most significant bit in the destination tag corresponding to bit 6 becomes the bit in position 6 of the first mask, and so on until the mask is complete. The second mask is created by first creating a data element in the same way the first mask was created except the second most significant bit of each destination tag is used. This data element is then subjected to a masking operation using the first mask. The output or resulting data element of the masking operation becomes the second mask. Each subsequent mask is created by first creating a mask data element from the corresponding bits in the destination tags. That is, a third mask data element will use the third most significant bits, a fourth mask will use the fourth most significant bits, and so on. Each of these mask data elements are then subjected to masking operations using the previous masks generated. For example, the third mask data element will first be subjected to a masking operation using the first mask and that result will then be subjected to a masking operation using the second mask to produce the third mask.

Proceeding in this manner will produce the same number of masks as there are bits in the destination tags. That is, if there are log(n) bits in each destination tag, then there will be log(n) masks created.

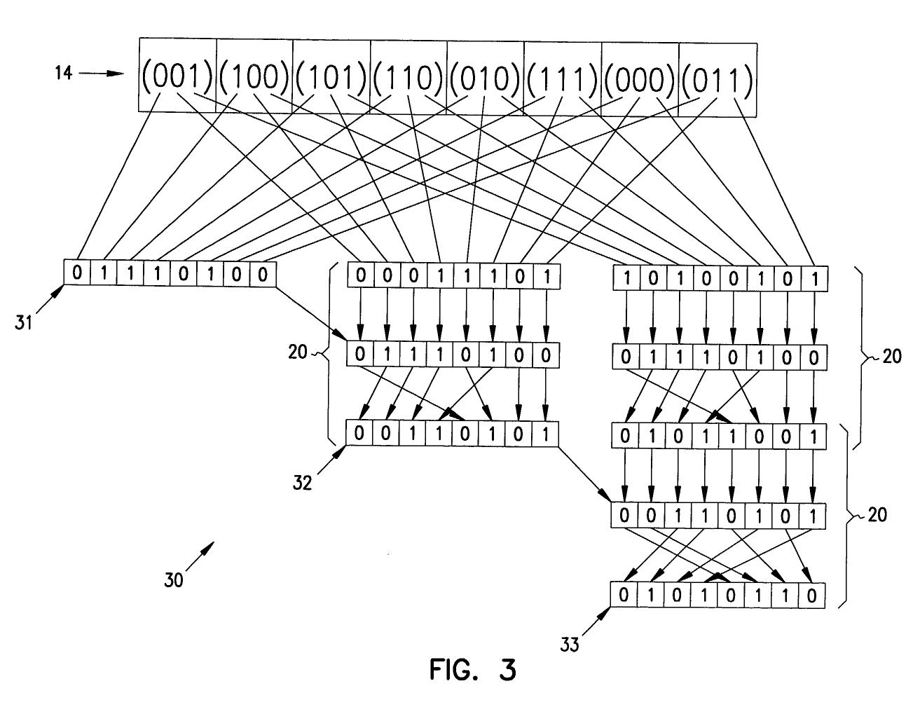

An example of how masks can be produced according to the present invention is illustrated in FIG. 3. In FIG. 3, a destination descriptor 14 representing a reordering pattern of an 8-bit data element is used to create three masks to be used in masking operations. The first mask 31 is created, as described above, by utilizing the most significant bit from each destination tag. The second mask 32 is created by first creating a mask data element using the second most significant bit from each destination tag and subjecting the mask data element to a masking operation 20 using the first mask 31. The third mask 33 is created by first creating a mask data element using the third most significant bit from each destination tag and subjecting the mask data element to subsequent masking operations 20 using both the first mask 21 and second mask 32 as shown in FIG. 3.

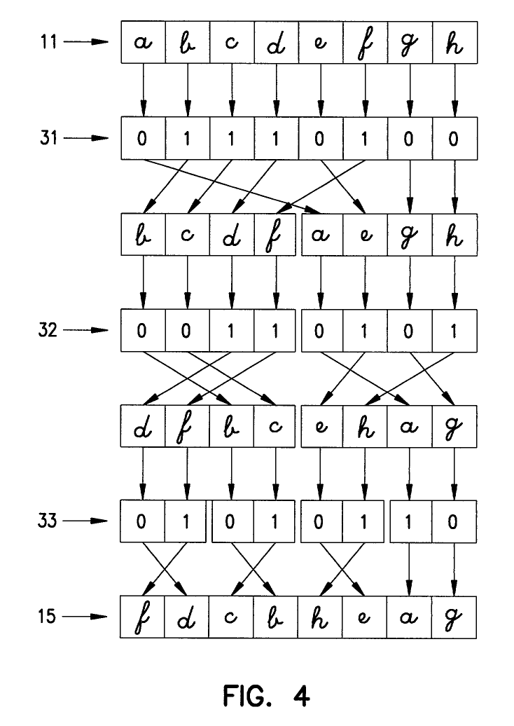

Once the masks are generated in accordance to the present invention, they can be applied in centrifuge operations to reorder data elements consistent with the destination descriptor used to create the masks. FIG. 4 illustrates an example of a reordering according to the present invention. In FIG. 4, mask 31, mask 32, and mask 33 are used to reorder data element 11 to produce resulting data element 15. It should be noted that, as part of the centrifuge operation, mask 32 is applied as two separate 4-bit masks and that mask 33 is applied as 4 separate 2-bit masks. It should also be noted that the application of the two 4-bits masks can take place simultaneously or in parallel, allowing the application of the masks to be thought of as a single masking operation. Similarly, the application of the 4 2-bit masks can be thought of as a single masking operation.

The present invention is especially efficient for applications requiring large numbers of data elements to be reordered according to the same reordering pattern. Such application may include, for example, signal processing and cryptography. Since the same pattern is used to reorder each data element the appropriate masks only have to be generated once. The same masks and centrifuge operations can then be applied to each data element to be reordered.

Additionally, a pipelined architecture can be implemented according to the present invention. For example, in a pipelined device in accordance with the present invention, each stage of the pipeline could be simultaneously applying a different masking operation to a different data element. Thus, in a device for reordering 8-bit data elements, the third mask could be applied to the first data element at one stage in the pipeline at the same time that the second mask is being applied to the second data element and the first mask is being applied to the third data element.

It should be noted that masks generated in accordance with the present invention generally will have an equal number of 0 bits and 1 bits. It is anticipated that hardware efficiencies may be employed in implementing embodiments of the present invention utilizing masks all having equal numbers of 0 bits and 1 bits.

In the above discussion, the term “computer” is defined to include any digital or analog data processing unit. Examples include any personal computer, workstation, set top box, mainframe, server, supercomputer, laptop or personal digital assistant capable of embodying the inventions described herein. Examples of articles comprising computer readable media are floppy disks, hard drives, CD-ROM or DVD media or any other read-write or read-only memory device. In one embodiment, aspects of the present invention are stored as instructions on a computer readable medium for distribution and installation on computers in other locations. For instance, the method of generating masks can be distributed for use on machines implementing a hardware or software centrifuge.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein. Moreover, the terms “first,” “second,” and “third,” etc. are used merely as labels, and are not intended to impose numerical requirements on their objects.

What is claimed is:

1. A method of reordering bits in a first data element where the destination position of each bit to be reordered is known, comprising:
forming a first mask as a function of the destination position of each bit to be reordered;
forming a second mask as a function of the destination position of each bit to be reordered; and
centrifuging the first data element as a function of the first and second masks.

2. The method according to claim 1, wherein forming a second mask includes forming a mask data element as a function of the destination position of each bit to be reordered and centrifuging the mask data element as a function of the first mask.

3. The method according to claim 1, wherein centrifuging the first data element as a function of the first and second masks includes:
centrifuging the first data element as a function of the first mask to form an intermediate data element; and
centrifuging the intermediate data element as a function of the second mask.

4. The method according to claim 1, wherein centrifuging the first data element as a function of the first and second masks includes:
providing a hardware centrifuge;
passing the first data element and first mask through the hardware centrifuge to form an intermediate data element; and
passing the intermediate data element and second mask through the hardware centrifuge.

5. A device for reordering the bits of a data element according to a desired pattern, comprising:
means for generating a sequence of masks derived from the desired pattern; and
means for applying the sequence of masks to the data element.

6. The device according to claim 5, wherein the means for generating a sequence of masks includes means for forming a first and a second mask as a function of the destination position of each bit to be reordered.

7. The device according to claim 5, wherein the means for applying the sequence of masks to the data element includes a hardware centrifuge.

8. The device according to claim 5, wherein the means for applying the sequence of masks to the data element includes a pipelined hardware centrifuge.

9. A computer readable medium having instructions written thereon, wherein the instructions, when executed on a computer, create a system for reordering the bits of a data element to a desired pattern, the system comprising:
means for generating a sequence of masks derived from the desired pattern; and
means for applying the sequence of masks to the data element..

10. The device according to claim 9, wherein the means for generating a sequence of masks includes means for forming a first and a second mask as a function of the destination position of each bit to be reordered.

11. The device according to claim 9, wherein the means for applying the sequence of masks to the data element includes a hardware centrifuge.

12. The device according to claim 9, wherein the means for applying the sequence of masks to the data element includes a pipelined hardware centrifuge.

13. A system for reordering the bits of a data element according to a desired pattern, comprising:
a centrifuge;
means for generating a sequence of masks derived from the desired pattern; and
means, connected to the centrifuge, for applying the sequence of masks to the data element using the centrifuge.

14. The device according to claim 13, wherein the means for generating a sequence of masks includes means for forming, within the centrifuge, a first and a second mask as a function of the destination position of each bit to be reordered.

15. The device according to claim 5, wherein the centrifuge is a pipelined hardware centrifuge.
